(19) United States
(12) Patent Application Publication
(10) Pub. No.: US 2010/0321501 A1
(43) Pub. Date: Dec. 23, 2010

(54) Electromagnetic Radiation Detector

(76) Inventor: Donald J. Arndt, San Francisco, CA (US)

Correspondence Address: PATENT-TECH, 1308 CROWN DRIVE, ALAMEDA, CA, 94501, US

(21) Appl. No.: 12/821,092

(22) Filed: Jun. 22, 2010

Related U.S. Application Data
(60) Provisional application No. 61/219,729, filed on Jun. 23, 2009.

(51) Int. Cl. H04N 5/30

(52) U.S. Cl. 348/162; 348/E05.085

(57) ABSTRACT

A device implemented with the present invention senses and converts unseeable electromagnetic (EM) energy such as high frequency radio, infrared, ultraviolet, etc. to an image in the human visual spectrum (red to violet—i.e. the rainbow). The size of the image and quality of the image is improved by rotating or oscillating the sensors in order to scan a broader array of electrometric energy.

The electromagnetic radiation detector (EMR) comprises: a sensor circuit that generates EMR signals of the scanned electromagnetic energy of the desired band of electromagnetic spectrum. The EMR detector further comprises processors that convert the EMR signals into image data that is used to generate the visible image of the scanned electromagnetic energy; and a motor that allows the sensor circuit to scan the electromagnetic energy. The sensor circuit may be a plug-in PCB module to allow ready selection of the desired frequency band.

### PRIORITY CLAIM

This application claims benefit of and hereby incorporates by reference provisional patent application Ser. No. 61/219,729, entitled “EMR Detector,” filed on Jun. 23, 2009, by inventor Donald J. Arndt.

### FIELD OF THE INVENTION

This invention generally relates to sensors of electromagnetic radiation, and more particularly to apparatus and methods of converting electromagnetic radiation to visible light.

### BACKGROUND OF THE INVENTION

There are a number of devices that are capable of sensing electromagnetic radiation and converting that energy into an information source. For example, there are devices that sense the unseen energy and then electronically convert the “electromagnetic energy” to the visible spectrum and display the image on a sensitive screen or video tube (see FIG. 1). These devices are use in a wide variety of applications including detection of the following environments; laptop hotspot, overheating circuit breaker, very hot pipe or wiring under the floor, energy audit, and veterinary and medical viewing.

This existing technology requires expensive conversions and the devices are limited to those portions of the frequency spectrum inherently designed in the instrument, so one has to purchase another instrument at great costs to detect another portion of the spectrum. It would be beneficial to have electromagnetic radiation detectors (EMR detector) that are able to easily configure for different portions of the electromagnetic spectrum. Further, it would be beneficial for the detector to be able to scan a wide field of view (or a continuous area) at an economical cost.

### SUMMARY

The present invention offers significant improvements in electromagnetic radiation detectors (EMR) to in their ability to “see” the “unseen” electromagnetic radiated energy. The improvements include adaptability to detect different spectrum bands, to generate images of electromagnetic energy and to reduce the cost. The present invention comprises an EMR detector for converting scanned electromagnetic energy into a visible image. The EMR detector comprises a sensor circuit where the sensor circuit generates EMR signals of the scanned electromagnetic energy of a selected band of electromagnetic spectrum. The EMR detector further comprises one or more processors and the one or more processors convert the EMR signals into image data that is used to generate the visible image of the scanned electromagnetic energy. Additionally, the EMR detector comprises a motor where the motor allows the sensor circuit to scan the electromagnetic energy. With this motor, the EMR detector is able to cover more EMR signals in a larger area as compared to a detector where the sensor does not scan.

The EMR detector further comprises a viewer's head where the viewer's head has translucent surfaces to allow the sensor circuit to scan the electromagnetic energy; and a base portion where the base portion is coupled to the top of the viewer's head and the base portion comprises processing and memory circuits. Other features include the sensor circuit that is located in the viewer's head and is coupled to the top of the base portion; the motor moves the sensor circuit to either oscillate or rotate around an axis relative to the base portion. The base portion of the EMR detector comprises at least one of the one or more processors.

Between the sensor circuit and the base portion information is communicated by bi-lateral wireless coupling. The method of communications may be either by magnetic induction and/or by light transmission and/or other wireless technology. Further, the sensor circuit is powered by the base portion by magnetic induction.

The EMR detector may be a hand-held device or a non-hand-held device. For the hand-held device, the sensor circuit oscillates around an axis relative to the base portion of the EMR detector and scans the electromagnetic energy, and further comprises a display; the display receives the image data and generates the visible image of the scanned electromagnetic energy for the user to see. The hand-held unit's display comprises LEDs, and the visible image may be displayed in an RGB format. The base portion of the EMR detector is shaped to be suitable for a hand-held device.

For the non-hand-held device, the sensor circuit rotates 360 degrees relative to the base portion to scan the electromagnetic energy; and the image data is coupled to a display that is off-board from the EMR detector.

The image resolution of the EMR detector increases with an increase in the number of sensor circuits and with the motor shifting each oscillation or rotation proportionally to the spacings of mounted sensor circuit and display.

The EMR detector may further comprises one or more acceleration sensors and/or one or more position sensors. With the output from acceleration sensors and/or position sensors, the image data is further processed then reconstituted into a larger visual image. In other words, the EMR signals and the signals from the combination of acceleration sensors and position sensors are processed to generate a reconstituted visual image, wherein the reconstituted visual image comprises the electromagnetic energy of a scanned continuous area.

The sensor circuit may be a PCB module that plugs into the EMR detector. This configuration allows the frequency spectrum of the EMR detector to be easily changed to a desired EMR frequency band.

### BRIEF DESCRIPTION OF THE DRAWINGS

FIG. 1 illustrates examples of prior art sensors and their applications.

FIG. 2 illustrates a pictorial view of a hand-held EMR detector in accordance with an embodiment of the present invention.

FIG. 3 illustrates a plug-in sensor of the EMR detector in accordance with an embodiment of the present invention.

FIG. 4a illustrates a side view of a hand-held EMR detector in accordance with to an embodiment of the present invention.

FIG. 4b illustrates a top view of a hand-held EMR detector in accordance with an embodiment of the present invention.

FIGS. 5a, 5b, and 5c illustrate different embodiments of sensors circuits and LEDs in accordance with the present invention.

FIG. 6 illustrates a block diagram of hand-held EMR detector in accordance with an embodiment of the present invention.

FIGS. 7a and 7b illustrates a top and side view of a non-hand-held EMR detector in accordance with an embodiment of the present invention.

FIG. 8a and FIG. 8b illustrates methods of converting scanned electromagnetic energy of a selected band of electromagnetic spectrum into a visible image

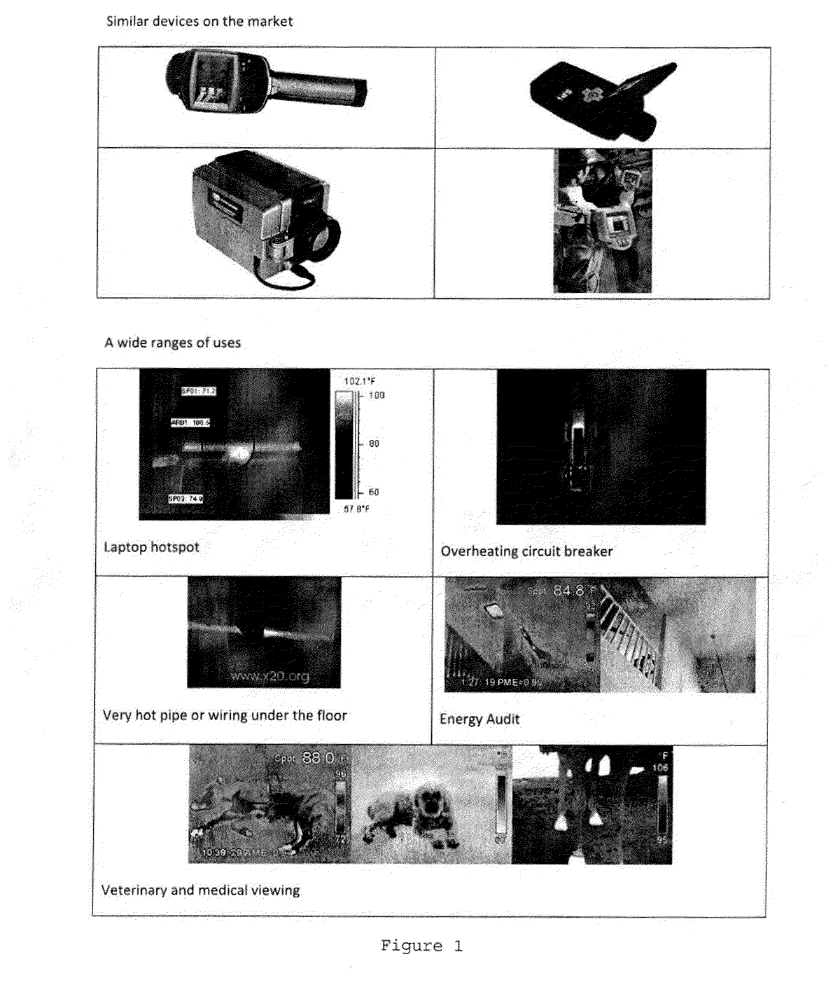

The components in the figures are not necessarily to scale, emphasis instead being placed upon illustrating the principles of the present invention. In the figures, like reference numerals designate corresponding parts throughout the different views.

### DETAILED DESCRIPTION

A device implemented with the present invention senses and converts unseeable electromagnetic (EM) energy such as high frequency radio, infrared, ultraviolet, etc. to an image in the human visual spectrum (red to violet—i.e. the rainbow). This device is called an EMR detector. The EMR detector may have viewing capability. The size of the image and quality of the image is improved by rotating or oscillating the sensors in order to scan a broader array of electromagnetic energy. A hand-held EMR detector may have a display.

Definitions relevant to this application include the following:

Electromagnetic Spectrum—The entire range of radiation extending in frequency from approximately 10²³ hertz to 0 hertz or, in corresponding wavelengths, from 10⁻¹³ centimeter to infinity and including, in order of decreasing frequency, cosmic-ray photons, gamma rays, x-rays, ultraviolet radiation, visible light, infrared radiation, microwaves, and radio waves. The range of radiation applicable to the EMR detector based on current technology is from 10²³ hertz to 10⁹ hertz.

Electromagnetic Radiation—Energy propagated through free space or through a material medium in the form of electromagnetic waves. Electromagnetic energy is equivalent electronic radiation.

Sensor—a device that responds to electromagnetic radiation or energy. Typically, sensors respond to a particular band of the electromagnetic spectrum. This may be called an electromagnetic radiation (EMR) sensor. A sensor circuit comprises a number of sensors and may comprise a number of display elements; for example LEDs.

EMR signals—the signal resulting from a sensor responding to electromagnetic energy.

Image data—data resulting from the EMR signals that has been processed so that it is suitable to be presented on a display.

Scanned continuous area—Scanning electromagnetic energy in both the x-axis and the y-axis.

Oscillation—The act of rotating a device in one plane around an axis for an amount of less than 360 degrees. For example, a sensor circuit PCB may oscillate back and forth for 90 degrees. A typical oscillation rate may be 10 to 30 times per second for example.

Rotation—The act of continuously rotating in one plane around an axis. For example, a sensor circuit PCB may continuously rotate the full 360 degrees around the vertical axis of the base portion of the EMR detector.

Acceleration sensors—Acceleration sensors are designed to detect changes in force resulting from tilt, motion, positioning, shock and vibration. A position sensor may be a three axis gyroscopic sensor.

Position sensors—A device for measuring a position and converting this measurement into a form convenient for transmission and further processing.

Reconstituted images—With acceleration sensors and/or position sensors, greater areas may be scanned and then reconstituted into a larger virtual “picture” of the area that was scanned by the electromagnetic radiation sensor. In other words, the image data resulting from the EMR signals and acceleration sensors and/or position sensors is further processed then “stitched” and “painted” into a reconstituted visual image comprising of the scanned electromagnetic energy. The further processed data from the EMR signals and acceleration sensors and/or position sensors is termed “processed image data”.

Combination of acceleration sensors and position sensors—The EMR detector may comprise a combination of acceleration sensors and position sensors. This means that there is either at least one acceleration sensor or at least one position sensor in the EMR detector. Of course, there may be more than one of either of these sensors in the EMR detector.

Bi-lateral wireless coupling—A method of coupling information to and from the sensor circuit and the base portion of an EMR detector. The method may be implemented with a combination of magnetic induction, and/or light transmission and/or other wireless technology. This combination may include any one, any two or any three of the aforementioned technologies. Magnetic induction may also be used to power the sensor circuit from the base portion of the EMR detector

Visual image and visible image are equivalent terms.

Off-board refers to components that are not located on the EMR detector.

The EMR detector comprises: a sensor circuit. The sensor circuit generates EMR signals of the scanned electromagnetic energy of the selected band of electromagnetic spectrum. The EMR detector further comprises one or more processors. The one or more processors convert the EMR signals into image data that is used to generate the visible image of the scanned electromagnetic energy; and a motor that allows the sensor circuit to scan the electromagnetic energy. Effectively, the movement of the sensor circuit allows the generation of a visual image.

The EMR detector further comprises a viewer's head that has translucent surfaces to allow the sensor circuit to “see” and scan the electromagnetic energy. Coupled to the bottom of the viewer's head is a base portion comprising memory and at least one of the one or more processors. The sensor circuit is located in the viewer's head and is coupled to the top of the base portion, wherein the sensor circuit either oscillates or rotates around an axis relative to the base portion. This may be a vertical axis or a horizontal axis, depending on the position of the EMR detector. Information is communicated bilaterally between the sensor circuit and the base portion, wherein the information maybe communicated by either magnetic induction and/or by light transmission. The sensor circuit is powered by the base portion by magnetic induction. The EMR detector further comprises one or more multiplexers and one or more control signals.

The EMR detector further comprises a combination of position sensors and/or accelerometers sensors. With these additional sensors, the EMR detector may tag the scanned data to support off-board stitching of the scanned images and “paint” a larger image.

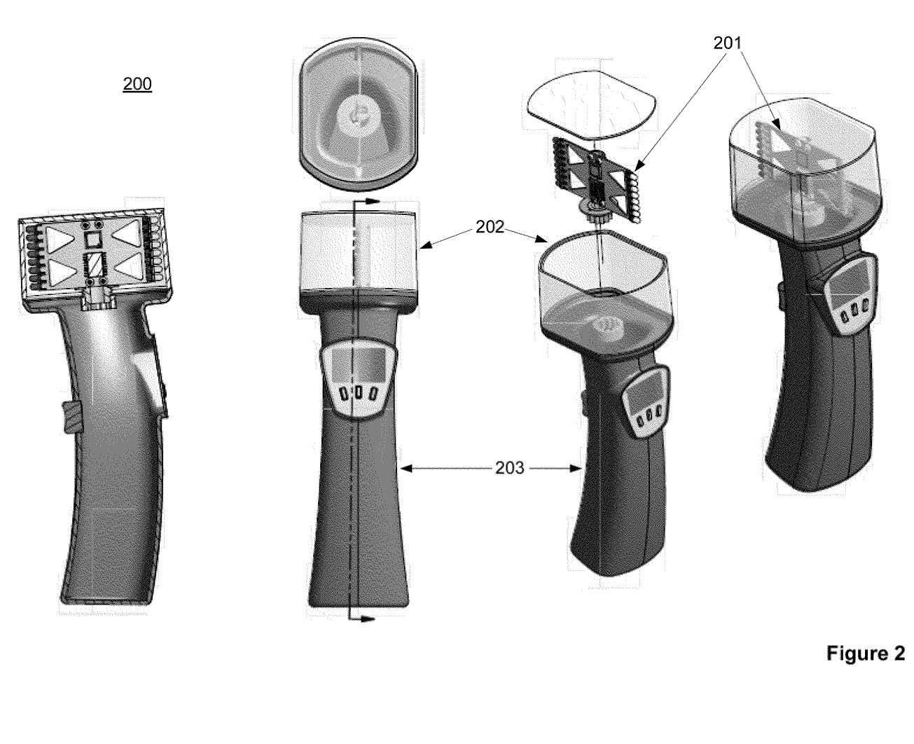

FIG. 2 illustrates a pictorial view of a hand-held EMR detector 200 in accordance with an embodiment of the present invention. As shown, the EMR detector 200 comprises a sensor circuit PCB 201, a viewer's head 202, and a base portion or handle 203.

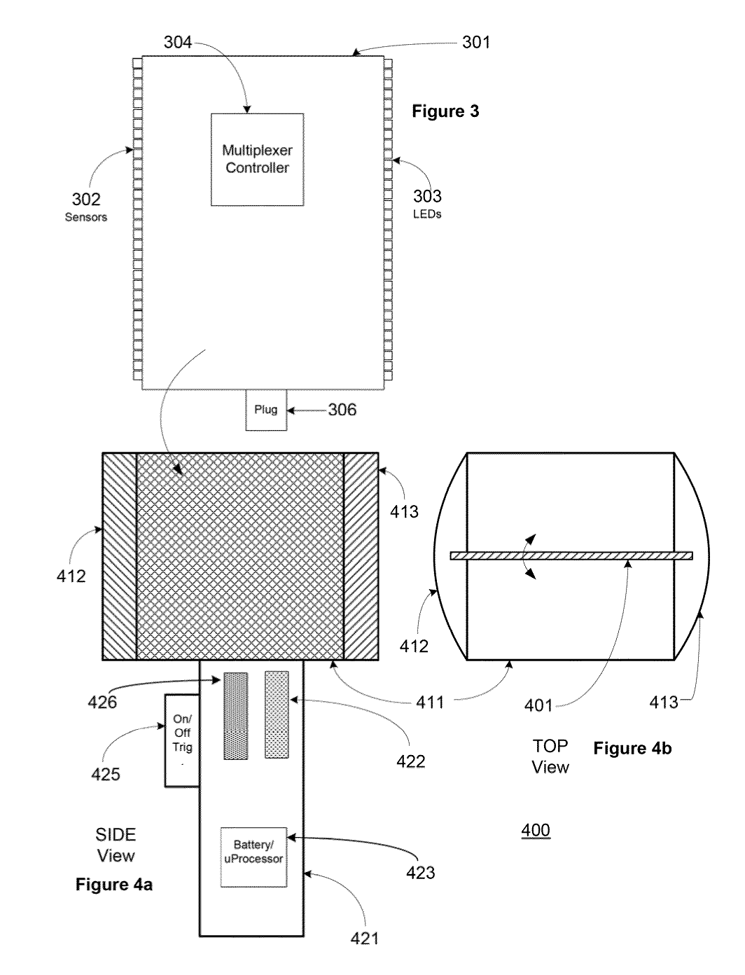

FIGS. 3 and 4a-b illustrate a simplified version showing a replaceable (plug-in) sensor circuit that is inserted at the top of a base portion that is shaped to be suitable for hand-held EMR detector 200. FIG. 3 illustrates sensor circuit 301 of the EMR detector in accordance with an embodiment of the present invention. FIG. 4a and FIG. 4b illustrate an embodiment of the hand-held EMR detector 200. The sensor circuit is illustrated in FIG. 4b as sensor circuit 401. The hand-held EMR detector 400 comprises a Viewer's head 411 and handle 421. The handle 421 is the base portion for this embodiment. Viewer's head 411 is located and secured on top of the handle 421. The Viewer's head 411 and the handle 421 are mechanically secured together. The Viewer's head 411 is stationary relative to the handle 421. Handle 412 also comprise a motor 426 and uProcessor/Battery 423. The EMR detector may be turned on or turned off by an ON/Off Trig 425.

The sensor circuit 301 is inserted into the Viewer's head 411 and mechanically plugs into handle 421 via plug 306. FIG. 4b shows the position of sensor circuit 401 in the top of the Viewer head 411. For the hand-held EMR detector 400, the sensor circuit 401 oscillates inside the Viewer's head 411. The sensor circuit 401 oscillates relative to an axis of the base portion or handle 421. The typical number of degrees of oscillation may be 90 degrees. Further, the sensor circuit 401 may oscillate approximately 10× to 30× per second. Sensors that oscillate will generate more EMR signals as compared to a sensor that does not move.

There are three main components that make up the present invention.

1) The first main component is sensor circuit 301 (or sensor circuit 401) that may be manufactured using standard printed circuit board (PCB) material or equivalent. Accordingly, sensor circuit 301 is implemented on a PCB module. As shown in FIG. 3, the sensor circuit 301 comprises sensors 302 and LEDs 303 that are attached to a PCB. Surface mount technology or equivalent may be utilized. One side of sensor circuit 301 comprises the sensors 302; the opposite side comprises the LEDs 303, as shown in FIG. 3. The LEDs 303 may be multicolored. The sensor circuit 301 also comprises multiplex functions and may include a controller function as shown in Multiplex/Controller 304. A controller function may be included in the sensor circuit 301 in order to minimize the number of connections to the main processor in the handle 421. This secondary processor on the sensor circuit 301 provides sequential sensor scanning, multiplexing and synchronization with the rotation/oscillation of the PCB. After the main processor has completed the EM up or down energy conversion, image data is sent to the LEDs for viewing.

The sensors 302 are selected based on their sensitivity to detect electromagnetic energy in a desired band in the electromagnetic spectrum. The electromagnetic spectrum for these bands may be in the IR, uV, RF, X-Ray bands, etc. and sensors 302 may be implemented with a variety of technology. For example, an RF sensor may be implemented with discrete edge chips or implemented with small antennas and a FH receiver. (FH=frequency hoping) Hence, a sensor circuit 301 may be selected with a frequency and bandwidth in the electromagnetic spectrum band of interest. One skilled in the art will recognize that sensors will continue to improve such that sensors of increasing frequencies and bandwidths may become available.

The sensor circuit 301 may contain an ID number to allow processors and drives that are not a part of the EMR detector to manage and respond to the characteristics of sensor circuit 301.

The sensors 302 are located on one edge of the sensor circuit 301 and the LEDs 303 are located on the other edge of the sensor circuit 301. When the EMR detector is being used, the sensor circuit 301 (or sensor circuit 401) oscillates. Thus, the image detected by the sensor circuit 301 is presented on the display created by display components, LEDs 303. As sensor circuit 301 oscillate, the LEDs 303 also oscillate while they are driven in a manner to create the visual image. The human eyes and brain are able to process the information presented on the oscillating LEDs and generate the visual image in their brain. In a typical embodiment the LEDs 303 will display the visible image in a RGB format. The sensors and LEDs are getting smaller and smaller, so as technology permits; one skilled in the art may predict that future plug-in cards will offer higher natural resolution.

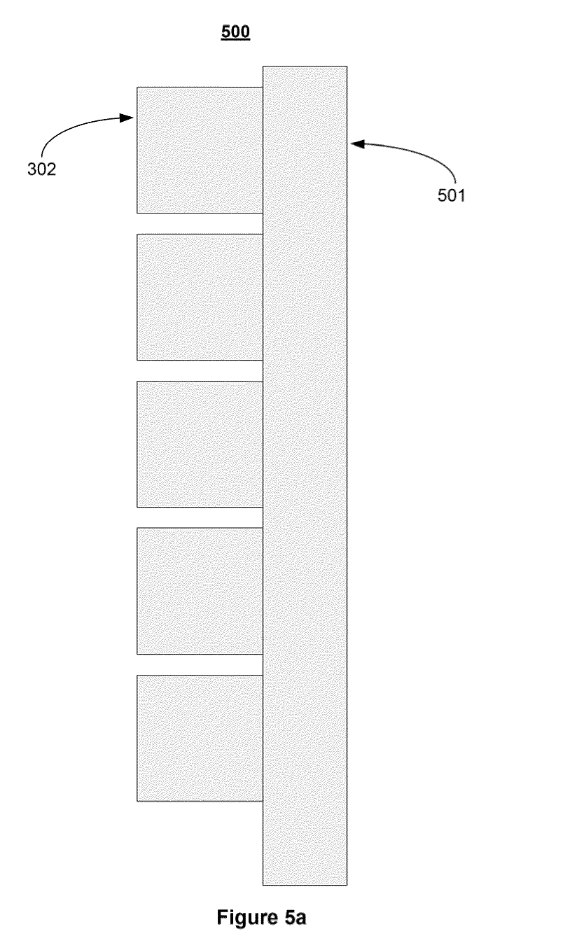

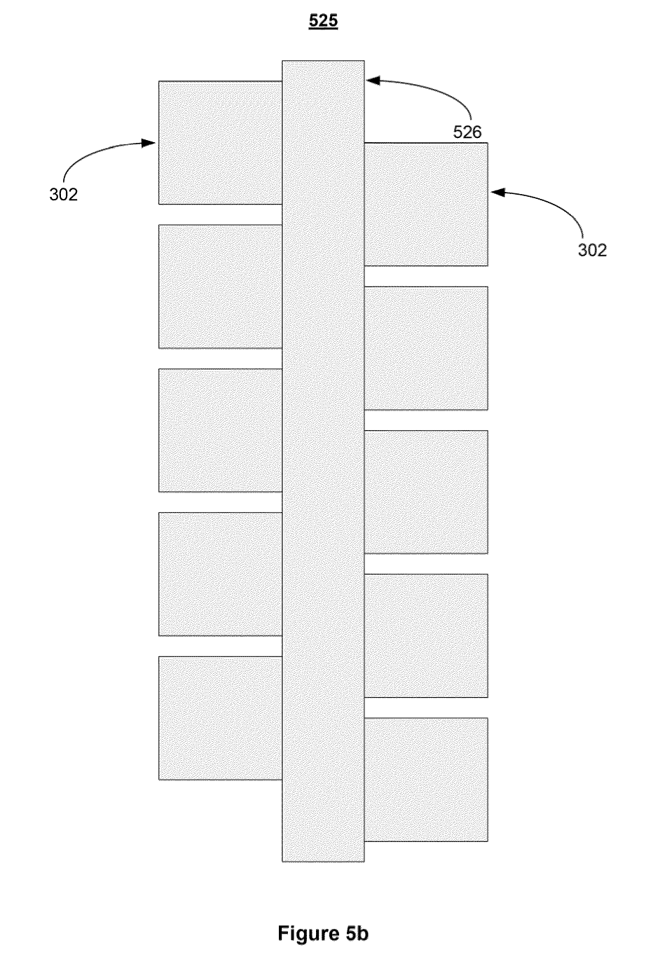

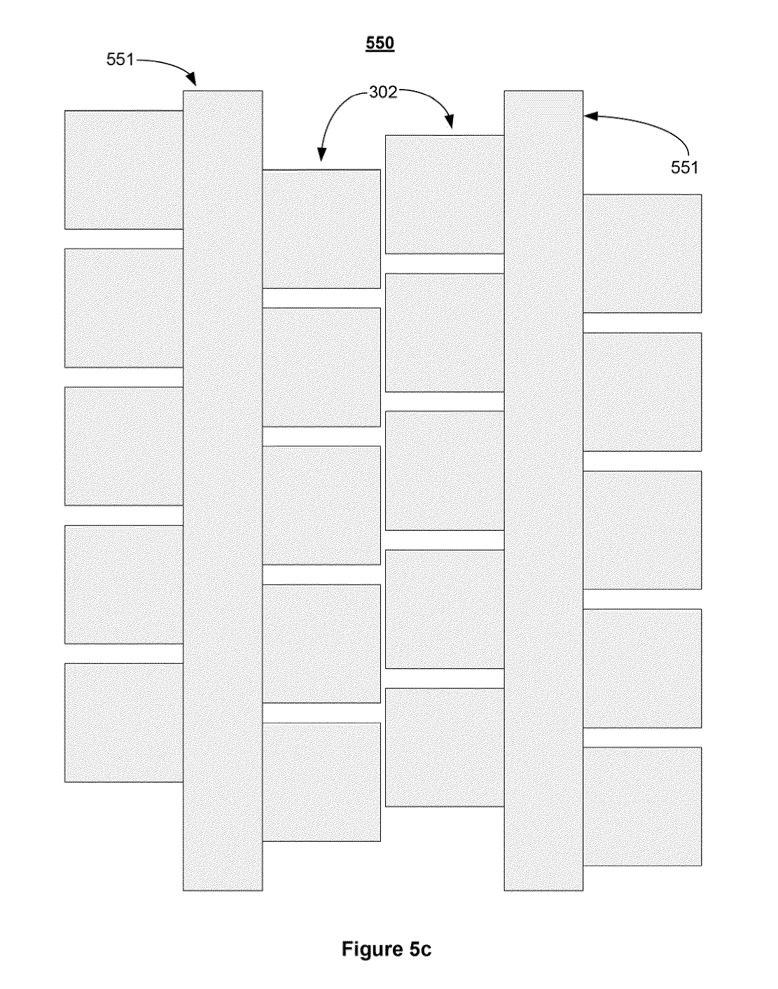

The sensors and LEDs may have a variety of configurations on the sensor board. For example, FIG. 5a illustrates embodiment 500 wherein there are several sensors 302 located on a front side of the PCB for sensor circuit 501. Alternatively, FIG. 5b illustrates embodiment 525 wherein there are sensors 302 located on the front and back sides of the PCB for sensor circuit 526. Further, FIG. 5c illustrates embodiment 550 wherein there are two sensor circuit 551 that are located in adjacent to each other. Each of the sensor circuit 551 has sensors 302 located on the front and back sides of the PCB, as was the case for FIG. 5b. In the case of embodiment 550, the associated base portion is configured to support a dual PCB configuration.

Naturally, the embodiments with a higher density of sensors may result in higher resolution images. The configuration also places additional requirements on the operation of the motor, as described below.

The configuration described in FIGS. 5a-c also applies to configurations for the LEDs 303.

2) The second main component is a main processor that receives the multiplexed and synchronized data from the sensor circuit 301. The multiplexed and synchronized data includes the accurate position of the rotating or oscillating sensor circuit 301. The main processor takes the synchronized data that is coupled from edge detectors or optical data transceivers within the hand-held device, and located under the moving sensor card. Commonly, the main processor is located in the handle 421 of the hand-held device, as illustrated by uProcessor/Battery 423. The main processor receives the sensor chip's energy values over their spectrum and converts that information to the visual spectrum for the visual LEDs. This bandwidth can be controlled by an adjustment on handle (thumb wheel or button adjuster 422) or can be predetermined by the characteristics of the specific sensor card that was inserted into the i.e. Viewer's head 411. Optionally, the main processor may be located on the sensor circuit 301. But since this component is the main processor, most of the architectures will locate this component in the handle of the EMR detector, for example, handle 421.

3) Finally, the third main component is motor 426 that oscillates and/or rotates the sensor circuit 401. As illustrated in FIG. 4a and FIG. 4b the sensor circuit 301 is inserted into the viewing head 411 and plugs-in to the handle 421. Motor 426 is located in the handle 421. Hence, when motor 426 oscillates, the sensor circuit 301 oscillates in the viewing head 411.

The quality of motor 426 is important in order to consistently move the sensor circuit 401 to maximize the resolution of what is being scanned at the front, and to slightly delayed in time for processing and to properly align what's scanned in front, left to right to the LED's left-right movement. If the sensor circuit 401 is rotating/oscillating around the vertical axis relative to handle 411, the highest resolution is found in the horizontal and the lowest in the vertical (due to the size of the sensors and LEDs and how closely they can be spaced and attached to the card/PCB).

The image resolution increases with an increase in the number of sensor circuits and with the motor to shifting each oscillation or rotation proportionally to the spacings of mounted sensor circuit and display. For example, the vertical resolution can be doubled or quadrupled by adding additional sensors to the sensor circuit 301, as illustrated in FIGS. 5a, 5b, and 5c. As previously discussed, FIGS. 5a, 5b, and 5c illustrate different embodiments of sensors circuits in accordance with the present invention. As shown, FIG. 5a illustrates sensors positioned on the front side at the edge of the PCB. FIG. 5b illustrates an embodiment with double the number of sensors since there are sensors located on the front and back sides of the edge of the PCB (i.e. double configuration). Finally, FIG. 5c illustrates an embodiment with two PCBs, where PCBs have sensors located on the front and back sides of the edge of the PCB (quadruple configuration). Depending on the sensor configuration, motor 426 has the additional task of slightly shifting each swing/rotation with half and quarter spacings of the mounted sensors and LEDs. The half spacing is associated with the double configuration and the quarter spacing is associated with the quadruple configuration. Further, by turning the hand-held device on its side, the vertical now has the highest viewing resolution.

The hand-held devices may also scan at multiple heights for more ‘visual resolution.

The viewing head 411 further comprises a clear/special (or lensed which can be changed also to match the sensor type and mounting pitch) plastic front window 412 and to a frosted rear window 413. The clear/special plastic front window 412 provides the “window” for the sensors 302 to scan the electromagnetic radiation and a frosted rear window 413 provide the viewing window for the LEDs 303.

The instructions to operate the hand-held EMR detector 200 are as follows: Instructions:
Turn OFF—Open top
Insert/replace PCB (sensor circuit 301)
Close top cover
Point at object/place and squeeze trigger 425.
The “range” for the EMR printed on PCB will be displayed (after slight delay for processing) in full color on rear screen
Advanced model (iC+) will have memory and will store video or snapshots of EMR converted data for PC processing and viewing using 3-axis position (gyro) and accelerometer circuits

Other characteristics of an EMR device includes the following:

For “'looking” at radio frequency (RF) EM energy (and other magnetic component energy), a different “sensor” would be used; the visual LED side may remain the same.

As radio has longer wavelengths than say uV or infrared, a single receiver may be used with multiple small antennas or moving antenna may then ‘feed’ the receiver. Then a sequential frequency jumping/hopping/multiplexed would occur over a select range of frequencies that would then be converted (equal, expanded or contracted) to a visual scale that then would be viewed as a visual spectrum with the LEDs (the lowest frequency in the scanned range would be red from the highest RF transferred to the blue/violet range of the visual spectrum).

The hand-held EMR detector 200 requires battery power (replaceable or rechargeable) to power the motor, the card/PCB circuitry and the main processor located in the handle. The handle itself comprises a trigger switch to turn on/off and may be augmented with a dial or control panel to allow the viewed unseen spectrum to be opened or compressed to make the viewing experience more useful.

It is also envisioned that “'plus” model would have a communication port such as USB to upload “conversion” scales and also allow the download of acquired scanning data for viewing and also enhancing/modifying on a computer.

Also, an advanced version may contain a combination of acceleration and/or position sensors so the greater areas can be scanned and then reconstituted into a larger virtual “picture” of the area the EMR detector was used to scan and interpret.

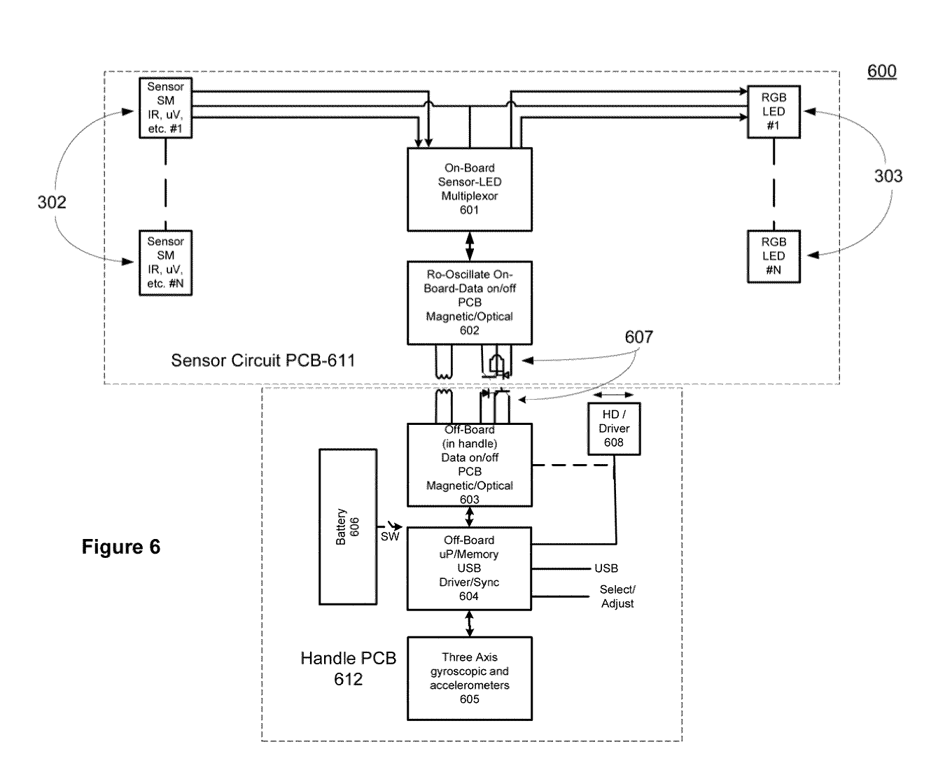

A detailed block diagram of the hand-held EMR detector is shown in FIG. 6 and embodiment 600. Embodiment 600 comprises sensor circuit PCB 611 and handle PCB 612. The sensors 302 are coupled to a sensor-LED multiplexer block 601 that generate multiplexed and synchronized data.

The multiplexed and synchronized data are then coupled to a rotate-oscillate data on/off block 602. The oscillate data on/off block 602 also comprises magnetic and/or optical circuits and/or other wireless technology that provides bi-lateral communications between the sensor circuit PCB 611 and the handle PCB 612. Hence, communications is facilitated without the use of wires. Per embodiment 600, the communication may be implemented by magnetic induction and/or by light transmission, as illustrated by circuits 607. The communications comprises image information resulting from the EMR signals and control data. The mutual induction also supports power coupling in order to power the sensor circuit PCB 611.

The multiplexed and synchronized data is received in the block 603 which is an equivalent function as block 602. The multiplexed and synchronized data is then coupled to an in-handle microprocessor and memory, block 604. Block 604 also comprises drivers for USB and hard drive interfaces. An input (Select/Adjust) to initiate the scan and adjust the scan is also included in block 604. Block 604 processes and coverts the multiplexed and synchronized data into image data. The image data is then coupled back to the sensor circuit PCB 611. through block 603, circuits 607, block 602, block 601, then coupled to the display comprising LEDs 303. In this embodiment, the image is displayed in an RGB format.

The handle PCB 612 also comprises a HD/Driver 608 and battery 606. The handle PCB 612 may comprise block 605 comprising a combination of three axis gyroscopic and/or accelerometer sensors to detect movement so an area may be scanned and stored. This processing allows for the creation of larger images based on the multiple scanned images.

The aforementioned invention may also be applied to a non-hand-held device. For this embodiment, the sensor circuit rotates 360 degrees relative to the base portion to scan the electromagnetic energy; and the image data is coupled to a display that is off-board from the EMR detector.

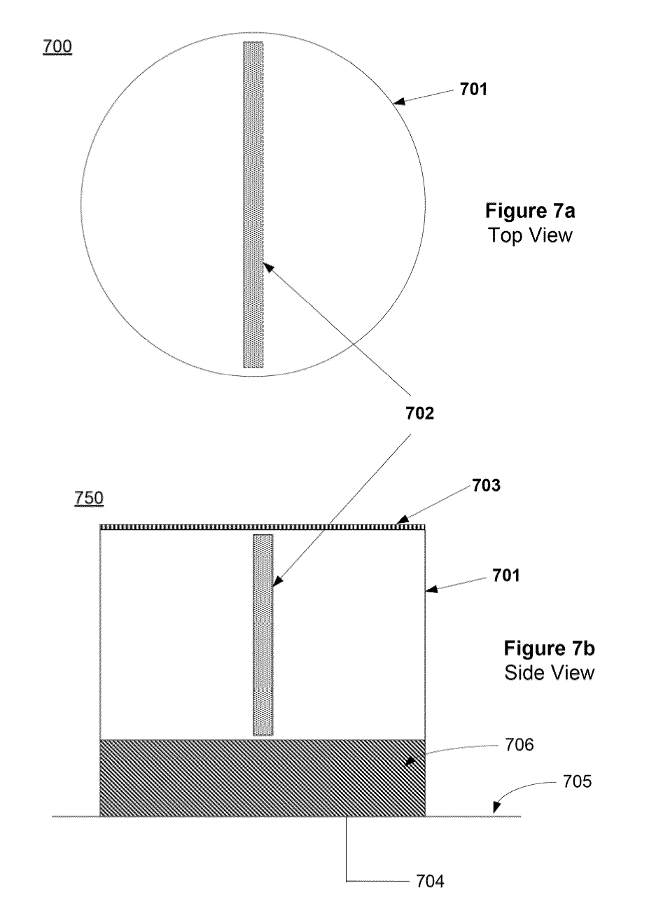

Per FIGS. 7a and 7b, for the non-hand-held device, the viewer's head and the sensor circuit PCB 702 rotate 360 degrees relative to a base portion or base unit 706. The base unit 706 is the base portion for this embodiment. The base unit 706 has some of the same functions as the handle of the hand-held device. As shown in FIGS. 7a and 7b, 700 is the top view of the non-hand-held device and 750 is the side view of the non-hand-held device. The viewer's head comprises an outer surface 701 and a removable top 703. The outer surface 701 of the device is a clear, frosted, or lenticular (bug's eye) surface. The outer surface 701 is stationary relative to the base unit 706. The sensor circuit PCB 702 rotates with sensors on one or vertical edges. For a non-hand-held embodiment, there are no LEDs. As shown in embodiment 750, there is a removable top 703 that may be removed when the viewer's head is not spinning so the sensor circuit PCB 702 may be removed and replaced.

The base unit 706 is stationary relative to the sensor circuit PCB 702 and the viewer's head. The base unit 706 comprises rotating drivers and circuits for magnetic inductance to power the sensor circuit PCB 702 and light transceivers to couple data to and from the rotating sensors. The data comprises sensor data and control data. The base unit 706 also comprises interfaces 704 with appropriate drivers to couple the image data to a display or memory, for example a USB interface. The base unit 706 may be located on a mounting surface 705, such as a vehicle roof.

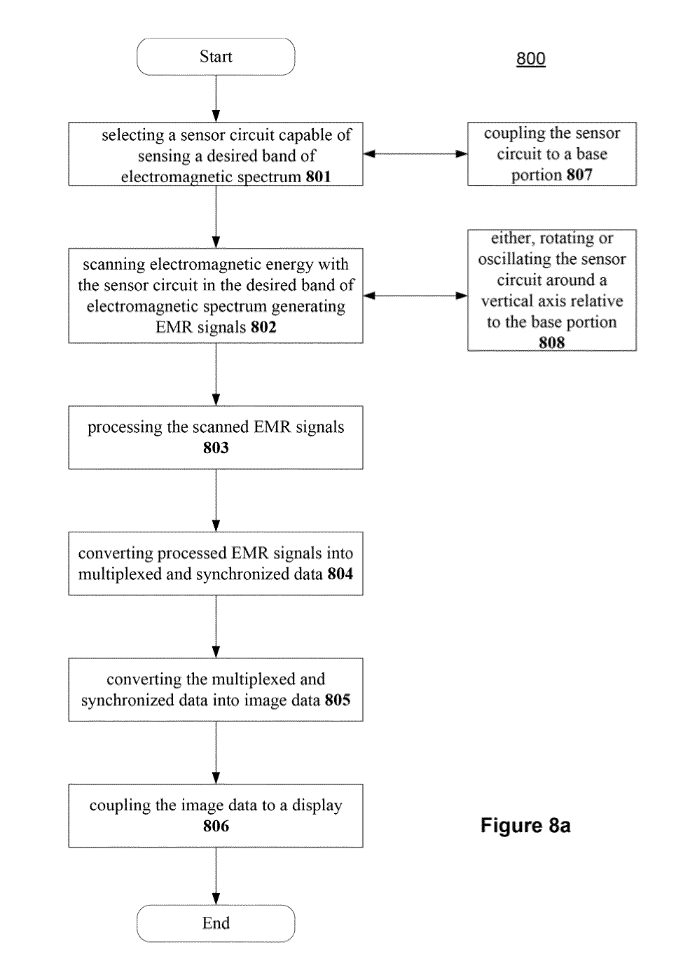

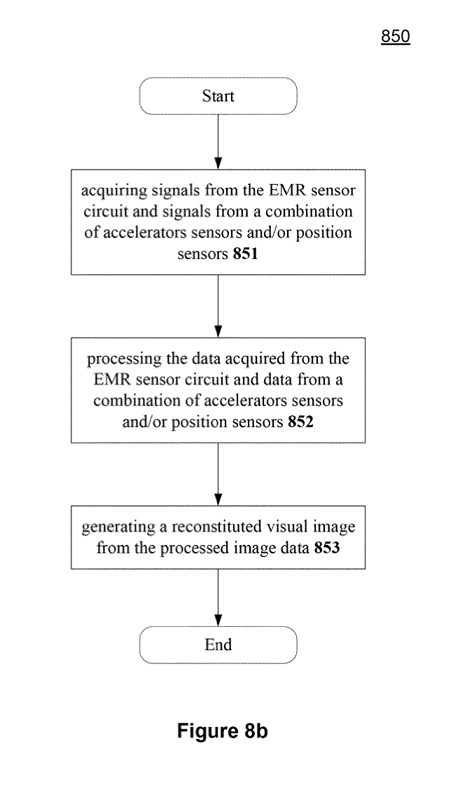

A method of converting scanned electromagnetic energy into a visible image as illustrated in FIG. 8a and FIG. 8b with flowchart 800 and flowchart 850.

The method comprising the steps of:
1. selecting a sensor circuit capable of sensing a desired band of electromagnetic spectrum 801;
2. scanning electromagnetic energy with the sensor circuit in the desired band of electromagnetic spectrum generating EMR signals 802;
3. processing the scanned EMR signals i.e. processing the scanned electromagnetic energy 803:
4. converting processed EMR signals (electromagnetic energy) into multiplexed and synchronized data 804;
5. converting the multiplexed and synchronized data into image data 805;
6. coupling the image data to a display 806.

Additionally, the method may comprise the steps of
1. coupling the sensor circuit to a base portion 807, wherein the base portion comprises at least one processor.
2. either rotating or oscillating the sensor circuit around a vertical axis relative to the base portion 808.

An advanced version may contain a combination of acceleration and/or position sensors so the greater areas can be scanned and then reconstituted into a larger virtual “picture” of the area the EMR detector was used to scan and interpret. In this case, the method comprises the steps of:
1. acquiring signals from the EMR sensor circuit and signals from a combination of accelerators sensors and/or position sensors 851;
2. processing the data acquired from the EMR sensor circuit and data from a combination of accelerators sensors and/or position sensors 852; and
3. generating a reconstituted visual image from the processed image data, wherein the reconstituted visual image is created by stitching and painting the processed image data that comprises the electromagnetic energy of a scanned continuous area 853.

The sensor circuit may be coupled to a base portion by either magnetic induction and/or by light transmission and/or other wireless technology. Additionally, the sensor circuit may be powered by the base portion by electromagnetic induction.

The present invention has several key differentiators to the existing products as depicted below:
1) Much less cost than current handheld technology
2) Replaceable sensor boards for different EM energy (RF, infrared, uV, etc.) and the sensor boards can be made on narrower or wider ranges so the user might carry a number of plug-ins depending on the job/task at hand.
3) Would have lower resolution in one plane (higher in the opposite plane), and the advanced unit with positional sensors may be used to far exceed the limited view and therefore relatively lower resolution of the current devices on the market.
4) The expanded spectrum available with just one unit with replaceable plug-ins (most units today limit themselves to the IR market while other portions of the EM spectrum are also very useful to be able to “see.”
5) The capability to add accelerator sensors and position sensors to improve the size and quality of the images. The EMR detector acquires and processes the data acquired from the EMR sensor circuit and data from a combination of accelerators sensors and position sensors and generates processed image data. A reconstituted visual image is created by stitching and painting the processed image data that to comprises the electromagnetic energy of a scanned continuous area.

While various embodiments of the invention have been described, it will be apparent to those of ordinary skill in the art that many more embodiments and implementations are possible that are within the scope of this invention. For example, any combination of any of the systems or methods described in this disclosure is possible. Further, these concepts may apply to any electromagnetic detection system.

What is claimed:

1. An EMR detector for converting scanned electromagnetic energy into a visible image, the EMR detector comprises:
a sensor circuit, the sensor circuit generates EMR signals of the scanned electromagnetic energy of a selected band of electromagnetic spectrum;
one or more processors, the one or more processors convert the EMR signals into image data that is used to generate the visible image of the scanned electromagnetic energy; and
a motor, the motor allows the sensor circuit to scan the electromagnetic energy.

2. The EMR detector of claim 1 wherein the EMR detector further comprises,
a viewer's head, the viewer's head having translucent surfaces to allow the sensor circuit to scan the electromagnetic energy; and
a base portion, the base portion coupled to the top of the viewer's head, the base portion comprising memory,
wherein the sensor circuit is located in the viewer's head and the sensor circuit is coupled to the top of the base portion,
wherein the motor moves the sensor circuit to either oscillates or rotates around an axis relative to the base portion,
wherein information is communicated between the sensor circuit and the base portion by bi-lateral wireless coupling.

3. The EMR detector of claim 2 wherein the information is bilaterally communicated between the sensor circuit and the base portion by a combination of magnetic induction and light transmission.

4. The EMR detector of claim 2 wherein the sensor circuit is powered by the base portion by magnetic induction.

5. The EMR detector of claim 2, wherein the EMR detector is a hand-held device, wherein:
the sensor circuit comprises a display, the display receives the image data and generates the visible image of the scanned electromagnetic energy, and
the base portion of the EMR detector is shaped to be suitable for a hand-held device.

6. The EMR detector of claim 5 wherein the display comprises LEDs, to and wherein the visible image is displayed in an RGB format.

7. The EMR detector of claim 5 wherein the sensor circuit oscillates around an axis relative to the base portion of the EMR detector and scans the electromagnetic energy.

8. The EMR detector of claim 2 wherein the EMR detector is a non-hand-held device, and wherein the image data is coupled to a display that is off-board from the EMR detector.

9. The EMR detector of claim 8 wherein the sensor circuit rotates continuously in one plane around an axis relative to the base portion to scan the electromagnetic energy.

10. The EMR detector of claim 2 wherein image resolution increases with an increase in the number of sensor circuits and with the motor shifting each oscillation or rotation proportionally to spacings of mounted sensor circuit and display.

11. The EMR detector of claim 2 wherein the base portion of the EMR detector comprises at least one of the one or more processors.

12. The EMR detector of claim 1 further comprising a combination of acceleration sensors and position sensors,
wherein the EMR signals and the signals from the combination of acceleration sensors and position sensors are processed to generate a reconstituted visual image,
wherein the reconstituted visual image comprises the electromagnetic energy of a scanned continuous area.

13. The EMR detector of claim 1 wherein the EMR detector further comprises one or more multiplexers and one or more control signals.

14. The EMR detector of claim 1 wherein the sensor circuit is a PCB module that plugs into the EMR detector,
wherein the sensors are located on one edge of the PCB module and display components are located on other edge of the PCB module.

15. A method of converting scanned electromagnetic energy into a visible image, the method comprising the steps of:
selecting an EMR sensor circuit capable of sensing a desired band of electromagnetic spectrum;
scanning electromagnetic energy with the sensor circuit in the desired band of electromagnetic spectrum;
processing the scanned electromagnetic energy;
converting scanned electromagnetic energy into image data; and
coupling the image data to a display.

16. The method of claim 15 wherein the sensor circuit further comprises the steps of:
coupling the EMR sensor circuit to a base portion,
either rotating or oscillating the sensor circuit around an axis relative to the base portion; and
wherein the base portion comprises at least one processor.

17. The method of claim 16 wherein the EMR sensor circuit is coupled to a base portion by bi-lateral wireless coupling.

18. The method of claim 16 wherein the EMR sensor circuit is powered by the base portion by electromagnetic induction.

19. The method of claim 16 wherein the method further comprises the steps of
oscillating the sensor circuit;
displaying the visible image on a portion of a EMR detector; and
shaping the based portion suitable for a hand-held device.

20. The method of claim 15 wherein the method further comprises the steps of
acquiring signals from the EMR sensor circuit and signals from a combination of accelerators sensors and position sensors;
processing the data acquired from the EMR sensor circuit and data from a combination of accelerators sensors and position sensors generating processed image data; and
generating a reconstituted visual image from the processed image data,
wherein the reconstituted visual image is created by stitching and painting the processed image data that comprises the electromagnetic energy of a scanned continuous area.
